(19) United States
(12) Patent Application Publication
(10) Pub. No.: US 2013/0202188 A1
(43) Pub. Date: Aug. 8, 2013

(54) DEFECT INSPECTION METHOD, DEFECT INSPECTION APPARATUS, PROGRAM PRODUCT AND OUTPUT UNIT

(71) Applicant: HITACHI HIGH-TECHNOLOGIES CORPORATION, Tokyo (JP)

(72) Inventors: Takahiro URANO, Ebina (JP); Toshifumi HONDA, Yokohama (JP); Shunji MAEDA, Yokohama (JP)

(73) Assignee: HITACHI HIGH-TECHNOLOGIES CORPORATION, Tokyo (JP)

(21) Appl. No.: 13/758,190

(22) Filed: Feb. 4, 2013

(30) Foreign Application Priority Data
Feb. 6, 2012 (JP) 2012-022652

(51) Int. Cl. G06K 9/62

(52) U.S. Cl. CPC G06K 9/6202
USPC 382/149; 382/145

(57) ABSTRACT

A defect inspection method has the following steps. An irradiation step of irradiating illumination light on an object. A detection step of detecting scattered light from the object. A defect detection step having the following steps. A first pixel-value information acquisition step of dividing an image based on the scattered light into multiple areas and obtaining first pixel value information, information of the pixel value about each of the multiple areas. A second pixel-value information acquisition step of acquiring second pixel value information, information of the pixel value about all the areas by processing the first pixel value information obtained. A similarity calculation step of calculating the similarity between each image of the multiple areas and the image of all the areas by comparing the first and the second pixel value information. A defect extraction step of extracting a defect of the object using the calculated similarity.

### BACKGROUND OF THE INVENTION

The present invention relates to a defect inspection method for inspecting a defect on a sample surface, a defect inspection apparatus, a program product, and an output unit.

Thin film devices, such as a semiconductor wafer, a liquid crystal display, and a hard disk magnetic head, are manufactured through many manufacturing processes. In manufacture of the thin film device, visual inspection is carried out for every series of manufacturing processings for the purpose of improvement in the yield and stabilization of the manufacture.

Patent Document 1 (Japanese Patent No. 3566589) discloses “a defect inspection method that has an illumination process of illuminating a slit-like beam that is almost parallel rays in a lengthwise direction on a substrate to be inspected on which a circuit pattern is formed, a detection process of receiving reflected scattered light obtained from a defect, such as a foreign matter, existing on the substrate to be inspected that is illuminated in the illumination process with an image sensor and converting it into a signal, and a defect determination process of extracting a signal indicating the defect, such as the foreign matter, based on the signal detected in the detection process” (Claim 1 of what is claimed). Moreover, Patent Document 1 (Japanese Patent No. 3566589) discloses a method for determining a defect based on difference images between images acquired from adjacent chips, for multiple images acquired from a large number of chips.

Patent Document 2 (Japanese Unexamined Patent Application Publication No. 2007-192688) discloses a defect inspection method “in which an image comparison unit performs registration of images using information of a misregistration quantity calculated by a misregistration detection unit, and after comparing a detected image and a reference image, determines an area in which a value of the difference is larger than a specific threshold as a defect candidate” (paragraph [0023] of its specification).

### SUMMARY OF THE INVENTION

In a semiconductor wafer that is an object to be inspected, being caused by flattening by cmp (chemical mechanical polishing) etc., even adjacent chips have a minute difference in film thickness, and thereby a difference in brightness arises locally between images of the chips. There are other factors that induce unevenness of brightness different in every area, such as a grain (minute unevenness of a surface), line edge roughness (ler), etc. In related art methods, such as Patent Document 1 (Japanese Patent No. 3566589) and Patent Document 2 (Japanese Unexamined Patent Application Publication No. 2007-192688), as a method for registering a detected image and a reference image, there is a method for determining a misregistration quantity by searching a position at which the degree of coincidence of detected images of a circuit pattern is the highest. However, there is a case where correct registration of the images cannot be performed because even with a pattern that is formed so as to be in an identical shape, the acquired image is seen differently due to an influence of nonuniformity of the brightness. When the registration is not attained correctly, the difference between the detected image and the reference image becomes large originating from misregistration, and a portion that is originally a normal part, it is erroneously detected as a defect.

Moreover, in order not to cause such erroneous detection, highly precise registration is needed, and in order to attain the highly precise registration, high computation cost is needed. Furthermore, in order to realize high-sensitivity defect inspection, it is necessary to attain the registration in units of a sub pixel, and there is a problem that a large computation cost is needed.

Therefore, this application provides a defect inspection method that is hard to carry out the erroneous detection of a defect even when there is the misregistration of the image, a defect inspection apparatus, a program product, and an output unit.

If an outline of a typical aspect of the invention that will be disclosed in this application is explained briefly, it goes as follows. It is the defect inspection method having: an irradiation step of irradiating illumination light on the object to be inspected; a detection step of detecting scattered light that is scattered from the object to be inspected due to irradiation by the irradiation step; and a defect detection step that has a first pixel-value information collecting step that divides the image based on the scattered light detected in the detection step into multiple areas and obtains first pixel value information that is information of pixel values about each of the multiple areas, a second pixel-value information collecting step that obtains second pixel value information that is information of pixel values about all the multiple areas by processing the first pixel value information obtained in the first pixel-value information collecting step, a similarity calculation step of calculating similarity between each image of the multiple areas and the image of all the multiple areas by comparing the first pixel value information and the second pixel value information, and a defect extraction step of extracting the defect of the object to be inspected using the similarity calculated in the similarity calculation step.

These and other objects, features and advantages of the invention will be apparent from the following more particular description of preferred embodiments of the invention, as illustrated in the accompanying drawings.

### BRIEF DESCRIPTION OF THE DRAWINGS

FIG. 1 is an outline block diagram of a first embodiment of a defect inspection apparatus according to the present invention;

FIG. 2 is a diagram showing one example of a configuration of a defect candidate extraction unit of the first embodiment of the defect inspection apparatus according to the present invention;

FIG. 3 is a diagram showing one example of a configuration of the defect candidate determination unit of the first embodiment of the defect inspection apparatus according to the present invention;

FIG. 4 is a diagram showing a configuration of a chip of a semiconductor wafer that is an object to be inspected and one example of category division;

FIG. 5 is a diagram showing one example of a feature space created using the defect inspection apparatus according to the present invention;

FIG. 6 is a diagram showing one example of a feature space creation unit of the first embodiment of the defect inspection apparatus according to the present invention;

FIG. 7 is a diagram showing one example of a local histogram and a whole histogram calculated using the defect inspection apparatus according to the present invention;

FIG. 8 is a diagram showing robustness against misregistration when the defect inspection apparatus according to the present invention is used;

FIG. 9 is a diagram showing one example of a graphic user interface when the defect inspection apparatus according to the present invention is used;

FIG. 10 is a diagram showing one example of parameter adjustment by the graphic user interface when the defect inspection apparatus according to the present invention is used;

FIG. 11 is a diagram showing one example of a configuration of a defect candidate determination unit of a second embodiment of the defect inspection apparatus according to the present invention;

FIG. 12 is a diagram showing one example of the local histogram and a whole histogram that are calculated using the second embodiment of the defect inspection apparatus according to the present invention and a whole histogram; and

FIG. 13 is a diagram explaining the first embodiment of a defect inspection method according to the present invention.

### DESCRIPTION OF THE PREFERRED EMBODIMENTS

Hereafter, embodiments of the present invention will be described in detail based on drawings. Incidentally, in all the diagrams for explaining the embodiments, the same symbol is given to the same component, and its repeated explanation is omitted.

### First Embodiment

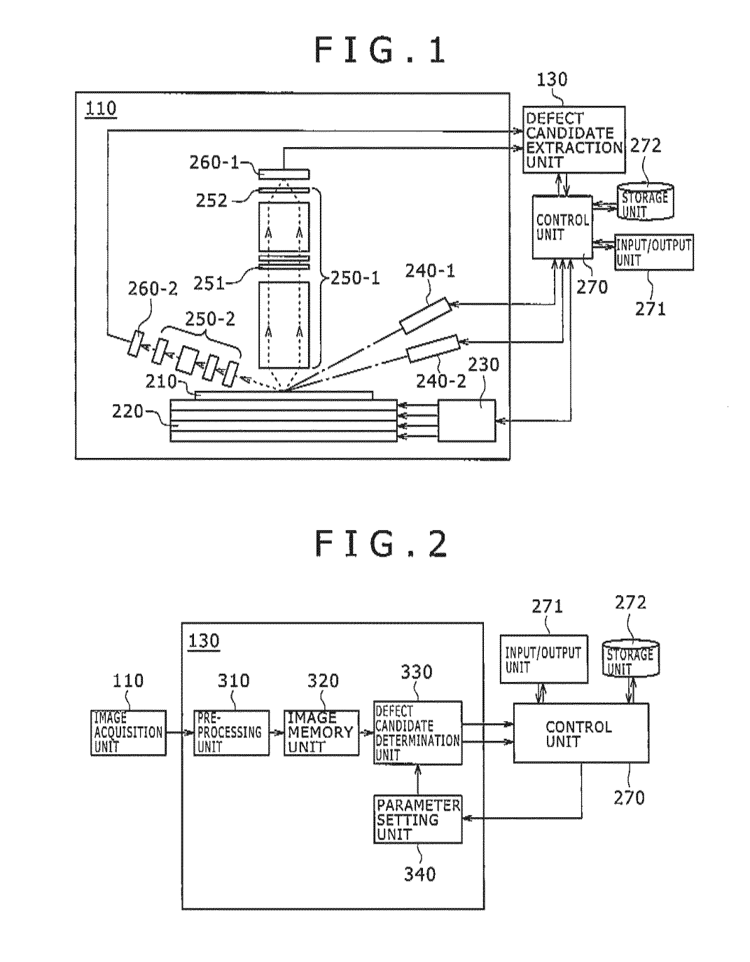

Hereafter, a first embodiment of a defect inspection technology (a defect inspection method and a defect inspection apparatus) of the present invention will be described in detail with FIG. 1 to FIG. 10.

As the first embodiment of the defect inspection technology of the present invention, the defect inspection apparatus and the defect inspection method both of which use dark field illumination that targets a semiconductor wafer will be explained taking them as examples.

FIG. 1 is an outline configuration diagram of the first embodiment of the defect inspection apparatus according to the present invention. The defect inspection apparatus is configured to have an image collecting unit 110 for irradiating illumination light on a sample 210 that is an object to be inspected and acquiring an image based on scattered light scattered from the sample 210, a defect candidate extraction unit 130 for extracting a defect candidate based on the image acquired by the image collecting unit 110, a control unit 270 for controlling the defect candidate extraction unit 130 and the image collecting unit 110, a storage unit 272 for storing image information etc. acquired by the image collecting unit 110, and an input/output unit 271 for inputting/outputting input/output data to/from the control unit 270.

### (Image Collecting Unit 110)

The image collecting unit 110 has a stage 220 on which the sample 210 is placed, a mechanical controller 230 for controlling movement of the stage 220, two illumination units 240-1, 240-2 as an illumination optical system (an illumination unit) 240, an upper detection system 250-1 for detecting scattered light that is scattered to the above of the sample 210 as a detection optical system 250, a slant detection system 250-2 for detecting the scattered light that is scattered slantingly, and image sensors 260-1, 260-2 each for detecting the image based on scattered light that is detected by the upper detection system 250-1 and the slant detection system 250-2, respectively, as an image sensor 260, and the detection optical system 250-1 has a space frequency filter 251 and an analyzer 252.

Here, the sample 210 is the object to be inspected, such as a semiconductor wafer, for example. The stage 220 carries the sample 210 and performs movement in an XY plane, rotation (θ), and movement in Z direction. The mechanical controller 230 drives the stage 220. Light from the illumination unit 240 is irradiated on the sample 210, scattered light from the sample 210 is imaged by the upper detection system 250-1 and by the slant detection system 250-2, and the imaged optical images are received by the respective image sensors 260-1, 260-2 and are converted into image signals. At this time, by mounting the sample 210 on an X-Y-Z-θ driven stage and detecting the scattered light from a foreign matter and a defect while the stage 220 is being moved in a horizontal direction, detection results are obtained as two-dimensional images. As an illumination light source of the illumination unit 240, either the use of a laser or the use of a lamp may be allowed. Moreover, light of a wavelength of each illumination light source may be a short wavelength, or may be light (white light) of wavelengths of a wide band. When the light of a short wavelength is used, in order to improve a resolution of the image to be detected (to detect a minute defect), light of a wavelength in the ultraviolet region (Ultra Violet Light: UV light) can also be used. When a laser is used as the light source and then when it is a laser of a single wavelength, it is also possible to provide a unit of reducing coherency (not illustrated) to each of the illumination unit 240.

By adopting a time delay integration image sensor (TDI image sensor) that is formed by two-dimensionally arranging multiple one-dimensional image sensors as the image sensors 260-1, 260-2 and then by transferring signals detected by the respective one-dimensional image sensors to a one-dimensional image sensor of the subsequent stage in synchronization with movement of the stage 220 to effect addition, it becomes possible to obtain the two-dimensional images in high sensitivity at comparatively high speed. By using a parallel output type sensor having multiple output taps as this TDI image sensor, outputs from the sensors can be parallel processed and faster detection becomes possible. Moreover, if a back irradiation type sensor is used for the image sensor 260, a detection efficiency can be raised compared with the case where a surface irradiation type sensor is used.

The two-dimensional images that are detection results outputted from the image sensors 260-1, 260-2 are transferred to the defect candidate extraction unit 130.

### (Defect Candidate Extraction Unit 130)

The defect candidate extraction unit 130 performs pre-processing on the transferred two-dimensional images that are the detection results outputted from the image sensors 260-1, 260-2, stores the corrected images in image memory, and extracts the defect candidate by processing the two-dimensional images stored in the image memory. A detailed configuration of the defect candidate extraction unit 130 will be described later using FIG. 2.

### (Control Unit 270)

The control unit 270 has a CPU (built in the control unit 270) for performing various controls, and is connected to the user interface unit (input/output unit) 271 that has a display part and an input part for receiving an alteration of inspection parameters (the kind of a feature quantity, a threshold, etc.) from a user and displaying detected defect information, respectively, and the storage device (storage unit) 272 for storing the feature quantity, the image, etc. of the detected defect candidate. The mechanical controller 230 of the image collecting unit 110 drives the stage 220 based on a control command from the control unit 270. Incidentally, the illumination optical system 240, the detecting optical system 250, etc. of the defect candidate extraction unit 130 and the image collecting unit 110 are also driven by commands from the control unit 270.

FIG. 2 is a diagram showing one example of a configuration of the defect candidate extraction unit of the first embodiment of the defect inspection apparatus according to the present invention. The defect candidate extraction unit 130 is configured to have: a pre-processing unit 310 for performing image correction, such as shading correction and dark level correction, on the image signal detected in the image collecting unit 110; an image memory unit 320 for storing digital signals of the images corrected in the pre-processing unit 310; a defect candidate determination unit 330 that compares the images of corresponding areas stored in the image memory unit 320 and extracts the defect candidate; and a parameter setting unit 340 for setting parameters of the processing.

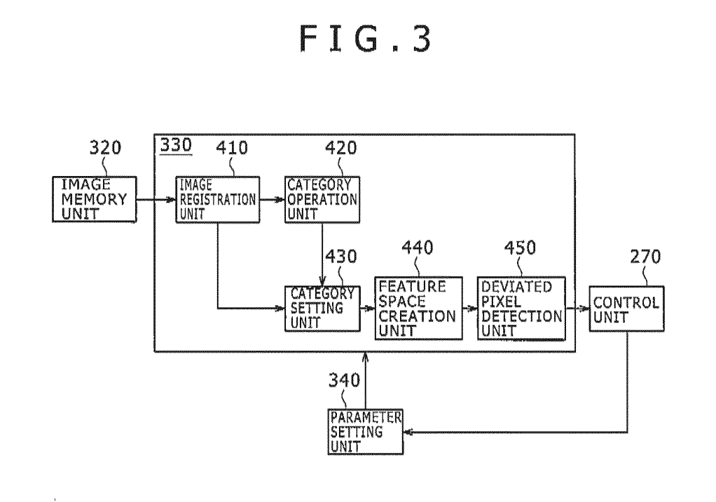

The pre-processing unit 310 performs image correction on the image data inputted from the image collecting unit 110, divides the image into images of a size of a fixed unit, and stores the divided images in the image memory unit 320. The image memory unit 320 reads the image data (digital signals) of the image of the inspection area (hereafter, described as a “detected image”) and the image of an area corresponding to the inspection area of the detected image (hereafter, described as a “reference image”) among the stored images. Here, the area of the reference image needs only to be a portion of roughly the same shape, such as a portion in which the same pattern circuit as the inspection area of the detected image is fabricated. For example, as the reference image, an image of a chip adjacent to the chip of the detected image may be used, or an ideal image that has no defect in its image that is generated from images of multiple chips adjacent to the chip of the detected image may be used. The parameter setting unit 340 sets up inspection parameters, such as the kind of feature quantity and the threshold when extracting the defect candidate that is inputted from the outside, and gives them to the defect candidate determination unit 330. The defect candidate determination unit 330 calculates an amount of misregistration (an amount of correction) for adjusting positions of the detected image and the reference image, performs registration (correction of the misregistration) of the detected image and the reference image using the calculated amount of correction, calculates various feature quantities from image data such as the detected image and the reference image that are registered etc., creates a feature space using the calculated feature quantity, and extracts a pixel that becomes a deviated value on the feature space as the defect candidate. An image, a feature quantity, etc. of the extracted defect candidate are outputted to the control unit 270. A detailed configuration of the defect candidate determination unit 330 will be explained using FIG. 3.

FIG. 3 is a diagram showing one example of a configuration of the defect candidate determination unit 330 of the first embodiment of the defect inspection apparatus according to the present invention. The defect candidate determination unit 330 is configured to have an image registration unit 410, a category operation unit 420, a category setting unit 430, a feature space creation unit 440, and a deviated pixel detection unit 450.

The image registration unit 410 detects the amounts of misregistrations (the amounts of correction) of the multiple images including the detected images and the reference image inputted from the image memory unit 320, and corrects the misregistrations of the multiple images. The category operation unit 420 category divides the multiple detected images each of whose misregistration is corrected by the registration unit 410 based on similarity of its background pattern of every image. The images inputted into the category operation unit 420 may be decided to be an image of a representative chip on the wafer, e.g., a first acquired image of the chip, or an ideal image having no defect in its image calculated from multiple chips. As the feature quantity serving as a standard of category division, gray values of the pixel of interest and its surrounding pixels may be used, or a variance, an entropy, a lightness gradient found by a Sobel filter, or the like may be used. Moreover, as a method of grouping, generally used pattern identification techniques, such as a classification by a decision tree, a classification by a support vector machine, and a classification based on a nearest neighbor rule, may be used based on the above-described feature quantity. Moreover, the category operation unit may divide patterns of the identical shape into the same category using a design data. Furthermore, the user can specify the category directly and can set it up.

The category setting unit 430 sets up the category division that was determined by the category operation unit 420 in advance to an image to be inspected that is inputted from the image registration unit 410.

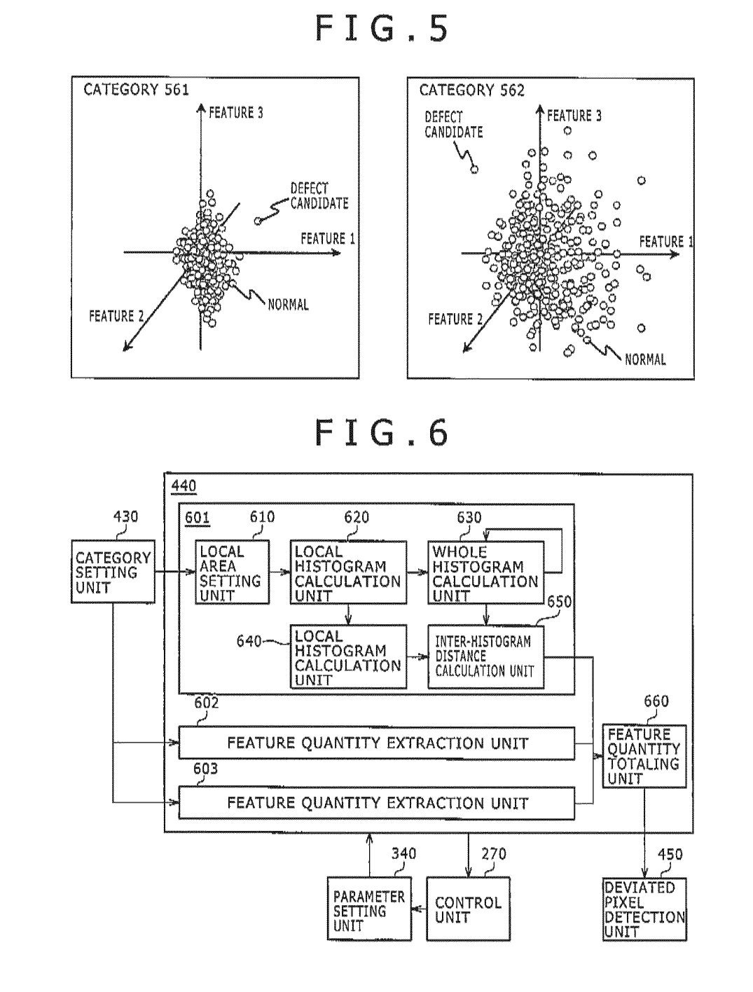

The feature space creation unit 440 creates the feature space for every category set by the category setting unit 430. In order to create the feature space, it is necessary to extract one or more feature quantities, and the feature space can be created by putting the extracted feature quantity on one axis. That a histogram distance (an image similarity) based on a distance between a local histogram found from a pixel of interest and its surrounding pixels and a whole histogram that integrates all the local histograms in a category is used as one of feature quantities is one of characteristics of this application. As feature quantities other than the histogram distance, there is an increase/decrease in brightness of the pixel of interest and its surrounding pixels of the detected image, etc. Moreover, as a general feature quantity, the brightness and contrast of the pixel of interest, a gray value difference with the images of adjacent chips, the brightness variance value of surrounding pixels, etc. may be used. Moreover, the feature space by the feature quantity of a different kind in every category may be created, and normalization may be performed based on a variation of defect candidates, etc. Details of a method for creating the feature space will be described later using FIG. 5 to FIG. 8. Next, the deviated pixel detection unit 450 outputs a pixel located at a deviated position in the feature space that the feature space creation unit 440 created as the defect candidate. Here, for a standard for determining the defect candidate, a variation in data points in the feature space, distances from the center of gravity of the data points, etc. can be used. At this time, a criterion may be determined using the parameter inputted from the parameter setting unit 340.

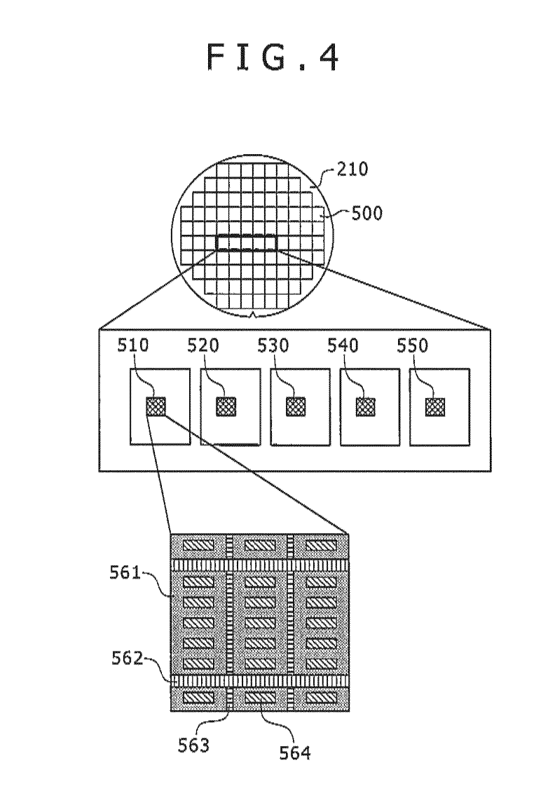

FIG. 4 is a diagram showing one example of a configuration of a chip of the semiconductor wafer that is the object to be inspected and the category division. In the sample 210 used as the object of inspection, many chips 500 of the same pattern are regularly arranged. The control unit 270 moves the semiconductor wafer 210 that is a sample continuously by the stage 220, and in synchronization with this, the images of chips are captured sequentially from the image sensors 260-1, 260-2. A diagram in which five chips formed being adjacent to one another in a central portion of the sample 210 is magnified is drawn in the middle of FIG. 4. Areas 510, 520, 530, 540, and 550 corresponding to the same position of respective chips arranged regularly include a circuit pattern as drawn in the bottom of FIG. 4, and this circuit pattern is divided into four categories 561, 562, 563, and 564. Here, the same fill pattern represents the same category. Such category division is performed by the category operation unit 420. In the category setting unit 430, areas of the sample 210 surface are set up for different categories 561, 562, 563, and 564 according to the categories divided by the category operation unit 420.

Although FIG. 4 showed the example where the category is set up for every area of the fixed range, the set-up category can be also set up in units of pixel and the number of divisions can be set arbitrarily. Thus, since by performing the category division, the feature space can be created and a statistic can be calculated using the images of the chips classified to the same category, it becomes possible to create a stable feature space even when the number of chips formed on the wafer is small.

FIG. 5 is a diagram showing one example of the feature space created by using the defect inspection apparatus according to the present invention. In the feature space creation unit 440 (FIG. 3), the feature space is created for every category set up by the category setting unit 430. A left diagram of FIG. 5 is the feature space created from the images of the area that is divided as category 561 in FIG. 4, which shows that the feature space is of a category in which a variation of the feature quantity of every chip is small. Moreover, a right diagram of FIG. 5 is the feature space created from the images of the area that is divided as category 562 in FIG. 4, which shows that the feature space is of a category in which a variation of the feature quantity is large. The deviated pixel detection unit 450 (FIG. 3) determines a deviated value of each feature space created by the feature space creation unit 440 as the defect candidate.

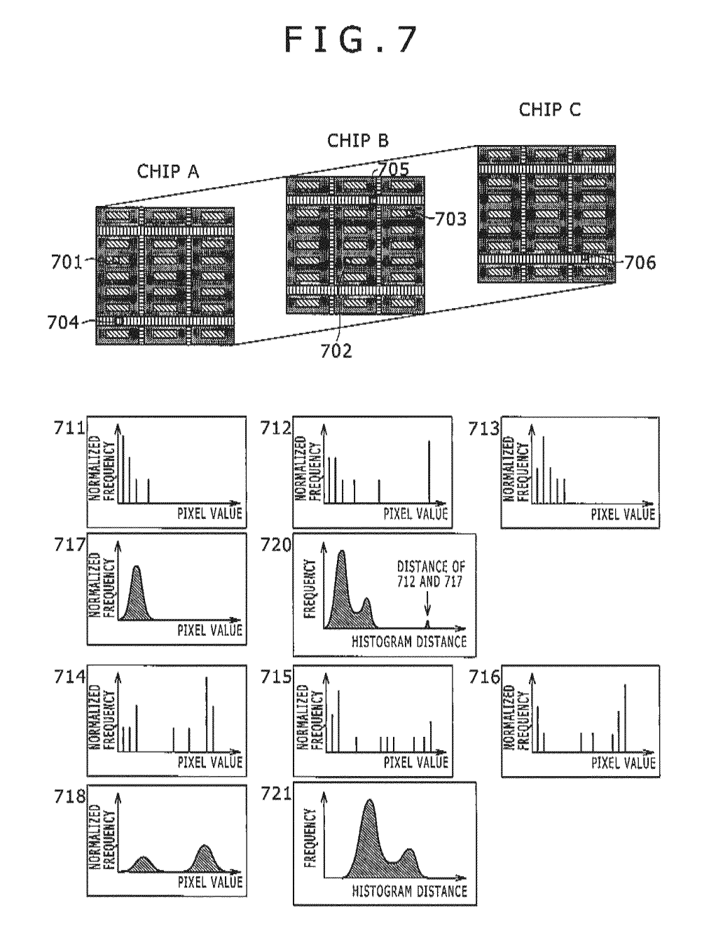

FIG. 6 is a diagram showing one example of the feature space creation unit of the first embodiment of the defect inspection apparatus according to the present invention. A method whereby the feature space creation unit shown in FIG. 6 calculates the distance between the local histogram and the whole histogram (the histogram distance, the image similarity) as the feature quantity that is one of features of this application will be described. The feature space creation unit 440 has inter-histogram distance feature quantity extraction units 601, 602, and 603 each of which extracts the feature quantity (the histogram distance, the image similarity) for every category that is set up by the category setting unit 430, and a feature quantity totaling unit 660 that totals the extracted feature quantities for respective categories created by the inter-histogram distance feature quantity extraction units 601, 602, and 603 and creates the feature space for every category. Moreover, the feature space creation unit 440 can render each extracted feature quantity into an image for user display, and can also store it in the storage unit 272 through the control unit 270. Here, although three symbols 601, 602, and 603 are described as the inter-histogram distance feature quantity extraction unit, it is noted that when the number of categories is five, for example, five inter-histogram distance feature quantity extraction units are necessary. Moreover, the inter-histogram distance feature quantity extraction units does not need to be provided as much as the number of categories, and may be configured in such a way that one common inter-histogram distance feature quantity extraction unit is provided and this portion is responsible to calculate the feature quantity according to each category. Moreover, the feature quantity totaling unit 660 may be provided as much as the number of the inter-histogram distance feature quantity extraction units. In the case where only one extraction unit is provided, it may be configured to create the feature space common to all the categories. If the feature quantity totaling unit 660 is for creating the feature space common to all the categories, miniaturization of the whole defect inspection apparatus can be realized.

The deviated pixel detection unit 450 determines the threshold for performing defect determination based on the statistic, such as a variation of the feature quantity of every category, and performs deviated value detection based on the determined threshold. Moreover, it stores the whole histogram and the feature space that were calculated for every category in the storage unit 272 through the control unit. Since the feature space is created for every category based on the similarity of a background pattern of the detected image, a distribution characteristic of a normal part is different for every category; therefore, high-precision defect determination becomes possible by setting the threshold according to it. The deviated-pixel detection unit 450 may be configured to collate the whole histogram and the feature space that are past inspection results with the whole histogram and the feature space that are calculated this time, specify an inspection result that is nearest to this time inspection result among the past inspection results, and determine parameters, such as the threshold, that were applied in the past results. In that case, since it becomes unnecessary to calculate the threshold to new image data, shortening of an inspection time can be attained.

Here, a configuration of the inter-histogram distance feature quantity extraction unit 601 will be explained. The inter-histogram distance feature quantity extraction unit 601 is configured to have a local area setting unit 610, a local histogram calculation unit 620, a local histogram storage unit 640, a whole histogram calculation unit 630, and an inter-histogram distance calculation unit 650. The local area setting unit 610 cuts out an area including an arbitrary pixel of interest and its surrounding pixels of the detected image (hereafter, described as a “local area”), and transmits information of the cutout local area to the local histogram calculation unit 620. The local area to be cut out may not be a rectangular area, but may be a circular shape centering on the pixel of interest etc. For example, the local area just needs to be a pixel area of 5×5 pixels centering on the pixel of interest, and multiple local areas can be cut out about the detected image by a predetermined cutout method. The local histogram calculation unit 620 creates the local histogram for each of the cutout multiple local areas with the pixel value put on the horizontal axis and the frequency put on the vertical axis, and stores it in the local histogram storage unit 640. When calculating a frequency of each pixel value, each pixel of the cutout area may be treated uniformly, or the frequency may be calculated after performing weighting on each pixel. For example, by performing the weighting according to a distance from the pixel of interest, it is possible to give the pixel near the center of the local area a strong contribution to the histogram and to make its influence smaller when the pixel approaches to a circumference of the local area. By performing such weighting, robustness against the misregistration can be improved further. Moreover, what is necessary is just to generate data obtained by finding the frequency of each pixel value for the cutout local area not creating the histogram itself, that is, to obtain distribution information of the pixel values of a portion of the detected image of the local area.

The whole histogram calculation unit 630 integrates multiple local histograms calculated by the local histogram calculation unit 620 for every category to create the whole histogram. Since the whole histogram is created for every category, the whole histograms as much as the number of categories will be created. From this whole histogram, one can know a tendency of the pixel values for every category, such as which pixel value of the pixels is major in each category. A range in which the local histogram and the whole histogram are calculated may be set for every category in the chip, or may be set for every category of an entire wafer. However, since a sum total of frequencies differs largely between the local histogram and the whole histogram, it is necessary to perform normalization so that the sum total may become unity. An integration method of the local histograms may be an average of frequencies of all the local histograms in the same category, or may be a weighted average obtained by setting arbitrary weights for the local histograms, respectively. Moreover, although in the above, it was said that the whole histogram was created for every category, it is also good to create one whole histogram with all the categories integrated by integrating all the local histograms created for respective categories.

Here, how to set the weighting when calculating the whole histogram will be explained. First, a provisional whole histogram is calculated by equalizing the local histograms or the like, and the similarity between the found provisional whole histogram and each local histogram is calculated. When the local histogram and the provisional whole histogram becomes more similar to each other, the whole histogram is re-calculated by putting a higher weight on that local histogram, and thereby a high-precision whole histogram from which an, influence of the deviated value, such as an influence of the defect, is eliminated can be calculated.

Next, the inter-histogram distance calculation unit 650 calculates a distance between the whole histogram calculated by the whole histogram calculation unit 630 and each local histogram that is calculated by the local histogram calculation unit 620 and is stored in the local histogram storage unit 640. The calculated distance (the histogram distance, the image similarity) is an index that shows a similarity between a distribution of the local histogram and a distribution of the whole histogram. Since the whole histogram is a histogram created by performing an integrated processing, such as equalizing multiple local histograms, it is understood that in the local area corresponding to the local histogram that has a low similarly with the distribution of the whole histogram, the pixel values have a singularity. A situation where the local histogram has a low similarity to the whole histogram, namely where there is a singularity in the pixel values of the local area means that a possibility that a foreign matter, such as a defect, exists in the local area is high. Therefore, it can be estimated in which local area the defect exists by calculating the distance between each local histogram and the whole histogram (the image similarity).

As a calculation method for the distance can use the histogram tolerance method that finds a summation of frequencies that is smaller one for every pixel value, Earth Mover's Distance that defines the inter-histogram distance as an optimal transportation cost by grasping it as a transportation problem, etc. Moreover, the inter-histogram distance can also be calculated after adjusting the brightness of the local histogram to that of the whole histogram. Either by using Earth Mover's Distance or by calculating the inter-histogram distance after inputting the both brightnesses, even when a variation of lightness has occurred in the image of each chip, the feature quantity robust against it is calculable.

FIG. 7 is a diagram showing one example of the local histogram calculated by using the defect inspection apparatus according to the present invention and the whole histogram. A local area 701 of the chip A, and a local area 702 and a local area 703 of the chip B are local areas classified into the same category, and local histograms 711, 712, and 713 are histograms calculated from the respective local areas 701, 702, and 703. Moreover, a whole histogram 717 is a histogram that is created by integrating the local histograms 711, 712, and 713. 720 is a distribution of distance calculated from the whole histogram 717 and the respective local histograms 711, 712, and 713, which indicates that the larger the distance, the higher the possibility that the defect exists in a corresponding local area becomes. For example, when the local area is supposed to be 5×5 pixels, since each local histogram becomes a histogram made up of data as much as the pixel values of 25 pixels, a distribution of frequency becomes a sparse histogram, whereas since the whole histogram is a set of multiple local histograms, a comparatively dense histogram thereof is created. In FIG. 7, although three local areas and the local histograms are described for the same category, in fact, the local area in which each pixel of the area being classified into the same category is designated as the pixel of interest (central pixel) will be created, and the local histogram will be created about the each local areas.

In the example of FIG. 7, since the local histogram 712 and the whole histogram 717 have a large distance (the histogram distance on the horizontal axis is large) compared with the other local histograms 711, 713, it is conceivable that a probability that the defect exists in the local area 702 corresponding to the local histogram 712 is high. Similarly, local histograms 714, 715, and 716 that were calculated from local areas 704, 705, and 706 classified into a category different from that of the local areas 701, 702, and 703 can be integrated to create a whole histogram 718. The histogram distances 721 can be obtained by finding the distances between the whole histogram 718 and the respective local histograms 714, 715, and 716. Since there is no deviated value in the histogram distance 721 like the histogram distance 720, it is conceivable that a probability that no defect exists is high.

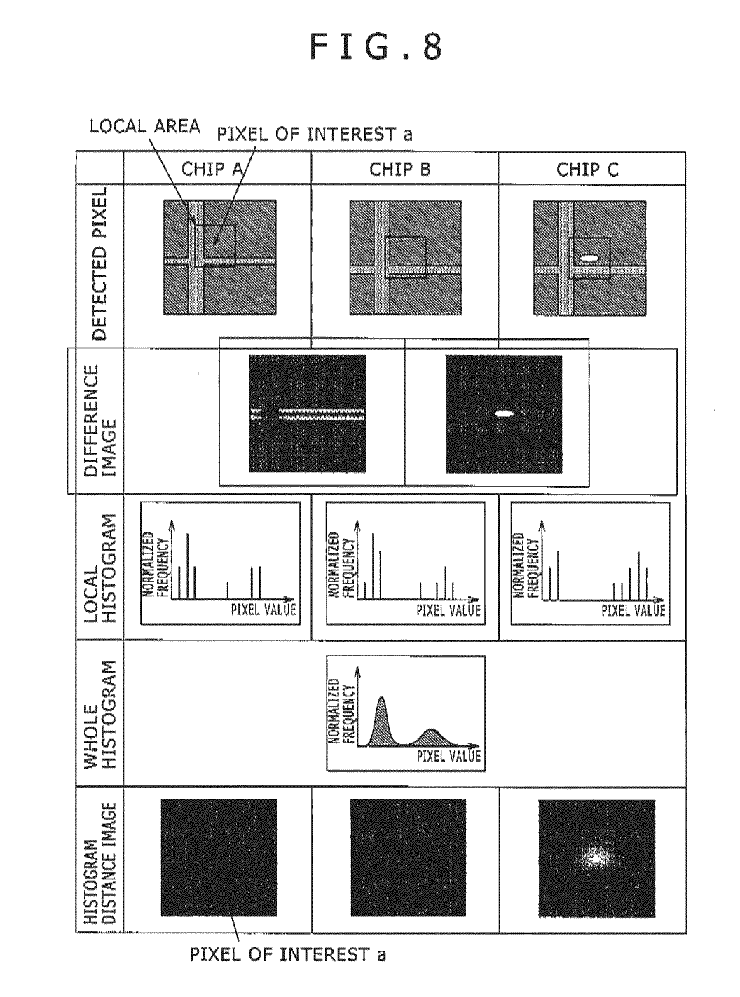

FIG. 8 is a diagram showing robustness against the misregistration when the defect inspection apparatus according to the present invention is used. Detected images are images that were acquired by taking multiple chips A, B, and C, and central frames show local areas. For example, a local area of the chip A is an area centering on a pixel of interest a. Difference images are a difference image of a detected image of the chip A and a detected image of the chip B, and a difference image of the detected image of the chip B and a detected image of the chip C. In the related art, defect extraction is performed by discriminating the lightness of the difference images shown here by the threshold. The misregistration has occurred in the local areas of the detected images of the chip A and the chip B, and the gray value difference caused by the misregistration has occurred in a difference image of the both images. Moreover, the defect exists in the chip C and the gray value difference has occurred in a defect portion in a difference image of the chip B and the chip C. By the method for determining a pixel of the gray value difference more than a certain level to be the defect like the related art, a gray value difference between patterns caused by the misregistration (a difference image obtained by the detected images of the chip A and the chip B) and a gray value difference caused by the defect (a difference image obtained by the detected images of the chip B and the chip C) cannot be discriminated, and therefore it is difficult to detect only the defect. The local histogram is created from the local areas of the chips A, B, and C, and shows a distribution of the pixel values of each local area. The local histogram corresponding to the chip A is created for the local area centering on the pixel of interest a. Here, since a pattern-less area, a lengthwise pattern, and an oblong pattern are included within the local area, the obtained distribution of the local histogram is a destitution having two peaks of the pixel value. Moreover, although a single local histogram is drawn in FIG. 8 correspondingly to the chip A, in fact, multiple local areas in the case where all the pixels of the chip A are considered as pixels of interest are set up, for example, and the local histogram is created for each of the multiple local areas. The whole histogram is created by performing the integrated processing on multiple local histograms created for respective chips A, B, and C. As described already, since the whole histogram is created, for example, by averaging multiple local histograms, it is a histogram showing an average distribution of the pixel values within the local area. A histogram distance image is an image that shows by gray levels a distance of the distribution of the whole histogram and the each distribution of the local histogram corresponding to the similarity of the both distributions. What expresses histogram distances 720, 721 of FIG. 7 by the gray levels of the images is equivalent to the histogram distance image, and this is used as the feature quantity. That is, the gray level of a portion corresponding to the pixel of interest a of the histogram distance image is determined based on the distance between the local histogram that is created from the local area centering on the pixel of interest a and the whole histogram. The local histogram is created for all the pixels, and the histogram distance image can be obtained by rendering the distance about each pixel into the image. Since the local histogram of the chip C had a large difference in shape from the whole histogram compared with the local histograms of other chips, the inter-histogram distance became large (the histogram distance image had a brighter pixel value as the distance was increasing). On the other hand, since both the distances between the local histograms of the chip A and the chip B and the whole histogram are small, it can be said that the histogram distance image is robust against the misregistration.

That is, although when the defect was extracted using threshold determination of a related art technique, there was a problem that erroneous detection resulting from the misregistration would occur, when the defect is extracted using the distance between the local histogram and the whole histogram of this application, it is shown that a true defect is detected correctly and the gray level of the image resulting from the misregistration is not erroneously detected.

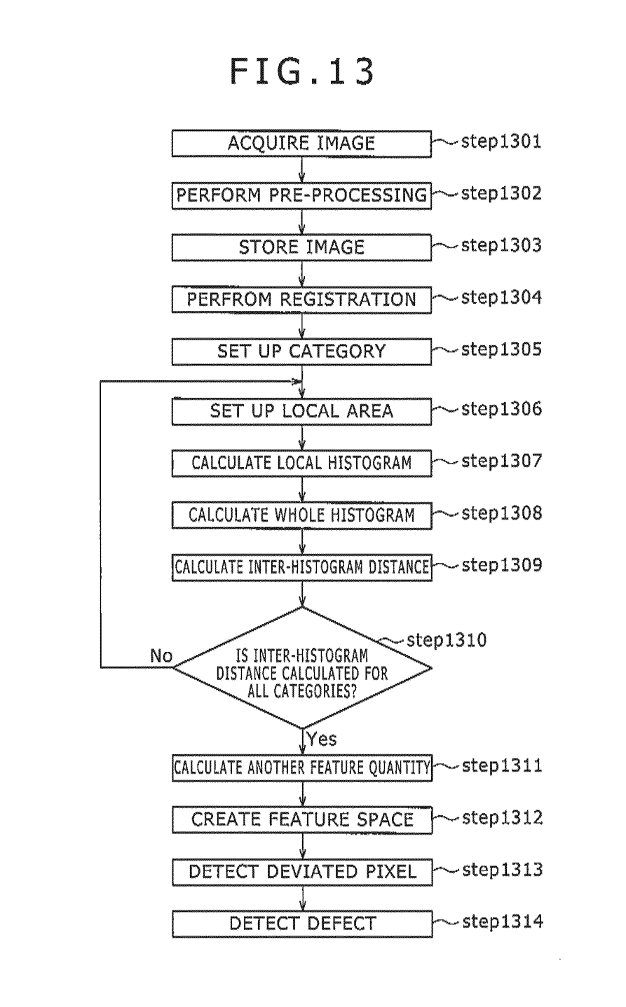

FIG. 13 is a diagram explaining the first embodiment of the defect inspection method according to the present invention. In Step 1301, the image of the object to be inspected is acquired using the image collecting unit 110 of FIG. 1. In Step 1302, the image acquired by the pre-processing unit 310 of FIG. 2 are pre-processed to reduce noises. In Step 1303, the image that was subjected to pre-processing is stored in the image memory unit 320. In Step 1304, the amount of misregistration (the amount of correction) between two pieces of the image data stored in the image memory unit 320 is calculated by the image registration unit 410 of FIG. 3 and the registration thereof is performed. In Step 1305, the category operation unit 420 divides the image of the object to be inspected into categories and the category setting unit 430 sets up categories that were divided by the category operation unit 420. In Step 1306, the local area of the image to be inspected is set up for every category set up in Step 1305 using the local area setting unit 610 of FIG. 6. In Step 1307, the local histogram calculation unit 620 creates the local histogram with a pixel value put on the horizontal axis for every local area set up in Step 1306. The local histogram shows a distribution of pixel values of the local area. In Step 1308, a whole histogram calculation unit 620 integrates the local histograms calculated in Step 1307 to generate the whole histogram. The whole histogram is created by equalizing the local histograms generated from the local areas of the same category or by an other processing, and one can know an average distribution of the pixel values of the category from it. In Step 1309, the inter-histogram distance calculation unit 650 calculates a distance between each local histogram and the whole histogram (similarity of distribution). Since a larger distance indicates that a pixel value of the local area corresponding to the local histogram is remote from the average, and since a probability that the defect exists in the local area can be measured by the distance, this is used for the defect extraction as the feature quantity. In Step 1310, it is determined whether the inter-histogram distance has been calculated for all the categories set up in Step 1305, and when there is a category for which the calculation is not done, Step 1306 to Step 1309 are repeated. In Step 1311, the feature quantity other than the inter-histogram distance is calculated. As general examples of the feature quantity, there are brightness and contrast of the pixel of interest, the gray value difference with pixels of an adjacent chip, etc., for example. The defect extraction may be performed only by the inter-histogram distance without using the feature quantity other than the inter-histogram distance. In Step 1312, the feature space is created based on the feature quantity calculated in Step 1309 and Step 1311 by the feature quantity totaling unit 660. In Step 1313, the deviated pixel detection unit 450 of FIG. 3 detects the deviated pixel based on the feature created in Step 1312, and the defect detection is performed in Step 1314.

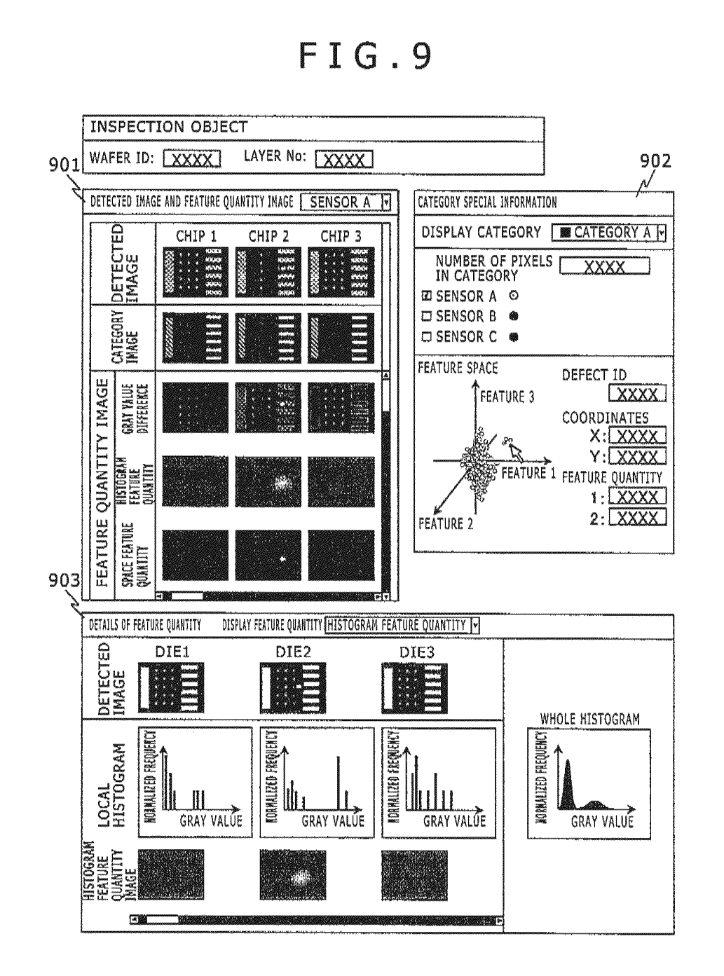

FIG. 9 is a diagram showing one example of the graphic user interface 271 (FIG. 1) when the defect inspection apparatus according to the present invention is used. On the top screen, a wafer ID and layer No. of the object to be inspected whose inspection result is displayed can be set. Moreover, the user can set up the kind of sensor (detection system) that displays the inspection result on a screen 901, can check the detected image, a category image, and an extracted feature quantity image, and can check a detection status of the defect by the feature space of an individual category on a screen 902. Here, a detected defect ID, its coordinates, and a value of the feature quantity are displayed. Moreover, in a screen 903, one can check the detected image in each DIE, the local histogram created from the detected image, the whole histogram created from multiple local histograms, a histogram feature quantity image corresponding to each histogram.

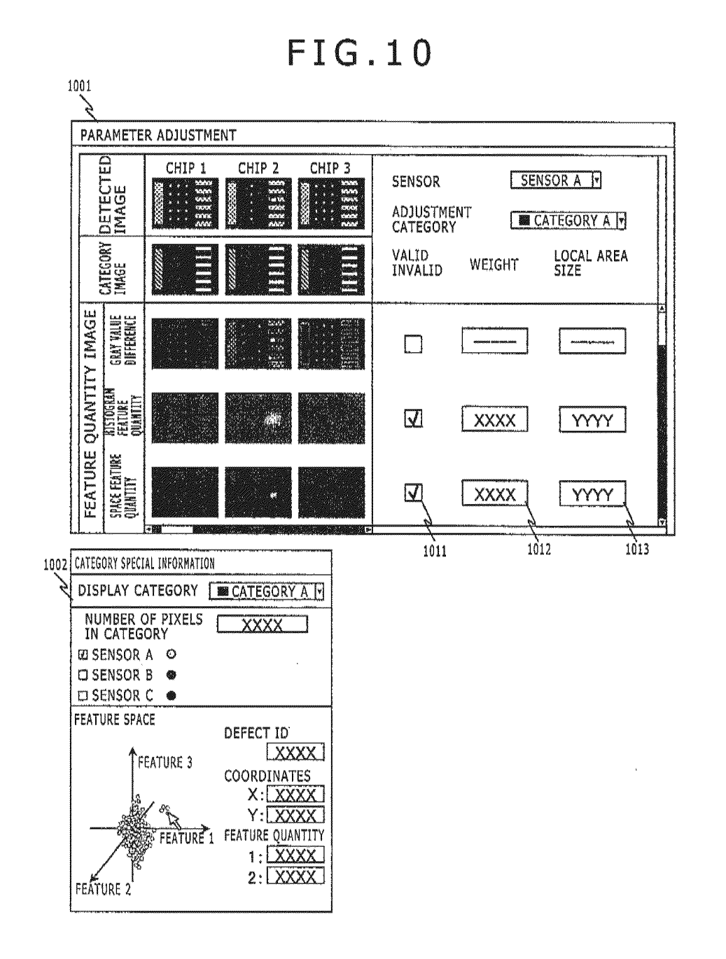

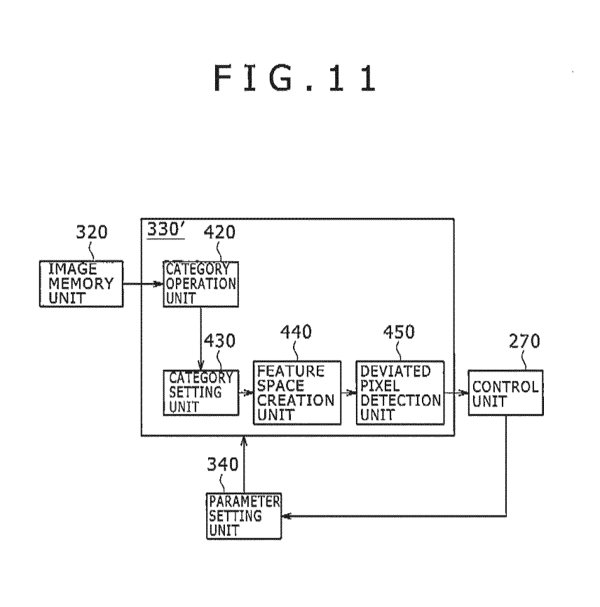

FIG. 10 is a diagram showing one example of parameter adjustment by the graphic user interface 271 (FIG. 1) in the case of using the defect inspection apparatus according to the present invention. The user is enabled to check the category image and the feature quantity image on a screen 1001 and to determine which feature quantity is used for creation of the feature space using a check box 1011. Moreover, when it is used, weighting can be determined in an input unit 1012. Moreover, the size of the local area for calculating the feature quantity can be specified in an input unit 1013. Thereby, the feature space by the feature quantity that is different in every category can be created. By extracting the feature quantity by a different local area for every category, it becomes possible to extract the feature quantity appropriately to a pattern of a different period. Moreover, these parameters can also be automatically determined based on the feature quantity extracted at the time of the category division and the area size of each category. Like the screen 902 of FIG. 9, a screen 1002 sets up the kind of category that is displayed as category special information, displays the number of pixels in the set-up category, displays the feature space created from the images of the set-up category, and displays an ID, coordinates, and a value of the feature quantity, etc. of the detected defect.

### Second Embodiment

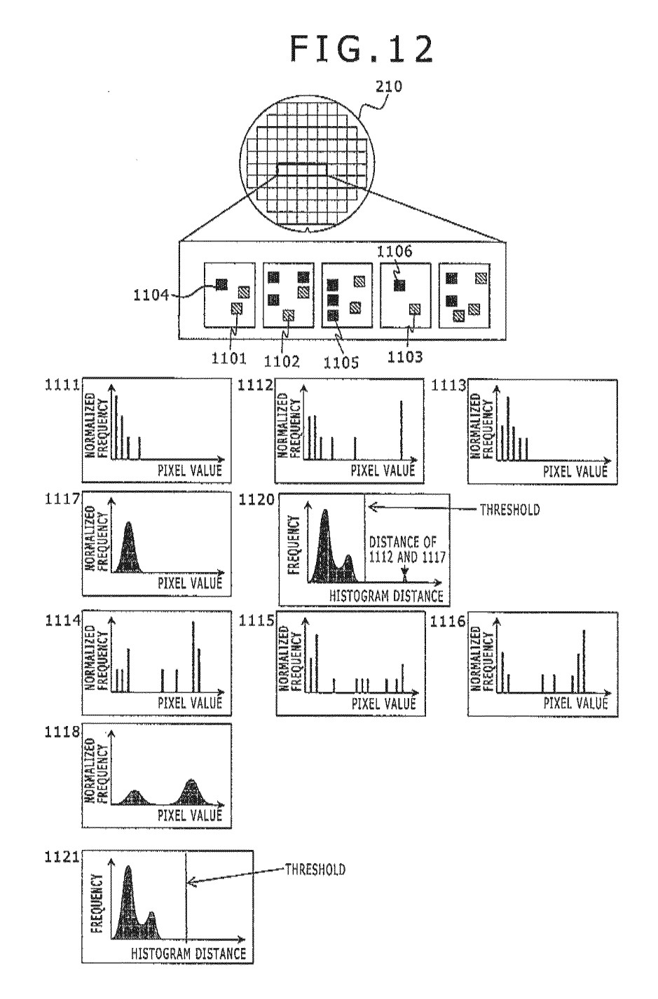

In the below, a second embodiment of the defect inspection technology of the present invention (the defect inspection method and the defect inspection apparatus) will be described with FIG. 11 and FIG. 12. Explanations of the same portions as those of the first embodiment are omitted.

Although in the defect inspection technology explained in the first embodiment, the category division was performed on the image of the representative chip and the category division was applied to other wafers, in the second embodiment, an embodiment where the category division is performed on the image of the entire wafer surface and the defect determination is performed. Since the registration between chip images becomes unnecessary by performing the category division on the entire wafer surface, the erroneous detection by the misregistration between the chip images ceases to arise. However, when the integrated processing by sensors (detection systems) of multiple conditions is performed, the registration between sensor images of the multiple conditions is necessary, and it is required to secure robustness against their misregistration.

FIG. 11 is a diagram showing one example of a configuration of a defect candidate determination unit 330′ of the second embodiment of the defect inspection apparatus according to the present invention. It differs from FIG. 3 in a respect that the defect candidate determination unit 330′ is of a configuration that does not have the image registration unit 410 because it negates a need of the registration between the chip images by executing the category division on the entire wafer surface.

FIG. 12 is a diagram showing one example of the local histogram and the whole histogram calculated using the defect inspection apparatus according to the present invention.

Each of areas 1101, 1102, and 1103 is a local area containing a pixel and its surrounding pixels that are divided into the same category, histograms 1111, 1112, and 1113 are local histograms that are calculated from the local areas 1101, 1102, and 1103, and a histogram 1117 is a whole histogram of the above-mentioned category. What are obtained by finding distances of the whole histogram to the respective histograms 1111, 1112, and 113 are histogram distances 1120, and since the similarity between a distribution of the local histogram 1112 and a distribution of the whole histogram 1117 is separated compared with those of the other local histograms, it shows that a probability that the defect exists in a local area 1102 corresponding to the local histogram 1112 is high. Moreover, when the distance with the local histogram 1112 exceeds the threshold, it is extracted as the defect. The threshold may be a value determined in advance or a value found according to a value of the histogram distance 1120 that was calculated.

Moreover, histograms 1114, 1115, and 1116 are local histograms calculated from respective local areas 1104, 1105, and 1106, and a histogram 1118 is the whole histogram of the category. Histogram distances thus found between the whole histogram 1118 and the local histograms 1114, 1115, and 1116 are histogram distances 1121, and since a distribution exceeding the threshold does not exist regarding the histogram distances 1121, no defect is extracted.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A defect detection method, comprising:
an irradiation step of irradiating illumination light on an object to be inspected;
a detection step of detecting scattered light that is scattered from the object to be inspected due to irradiation by the irradiation step; and
a defect detection step that has:
a first pixel-valve information acquisition step of dividing an image based on the scattered light detected in the detection step into a plurality of areas and obtaining first pixel value information that is information of pixel values about each of the areas;
a second pixel-value information acquisition step of obtaining second pixel value information that is information of the pixel values about all the areas by processing the first pixel value information obtained in the first pixel-value information acquisition step;
a similarity calculating step of calculating similarity between each image of the areas and an image of all the areas by comparing the first pixel value information and the second pixel value information; and
a defect extraction step of extracting a defect of the object to be inspected using the similarly calculated in the similarity calculation step.

2. The defect inspection method according to claim 1,
wherein in the first pixel-value information acquisition step, first pixel value information that is distribution information of the pixel values about each of the areas is obtained, and
wherein in the second pixel-value information acquisition step, second pixel value information that is distribution information of the pixel values about all the areas.

3. The defect inspection method according to claim 1,
wherein
in the defect inspection step,
a feature space is created by designating the similarity calculated in the similarity calculation step as one feature quantity and a deviated pixel in the feature space is extracted as the defect.

4. The defect inspection method according to claim 1,
wherein the defect detection step further comprises a feature quantity calculation step of calculating a feature quantity different from the similarity calculated in the similarity calculation step, and
wherein in the defect extraction step, a feature space is created by using the feature quantity calculated in the feature quantity calculation step and the similarity calculated in the similarity calculation step.

5. The defect inspection method according to claim 1,
wherein in the pixel-value information acquisition step, the images based on the scattered light are classified into a plurality of categories, and subsequently the image is divided the areas for every category.

6. The defect inspection method according to claim 3,
wherein in the first pixel-value information acquisition step, the images based on the scattered light are classified into a plurality of categories, and subsequently divides the image into a plurality of areas for every category of the categories, and
wherein in the defect extraction step, the feature space is created for every category of the categories.

7. The defect inspection method according to claim 1,
wherein in the first pixel-value information acquisition step, the category classification is performed based on similarity of a background pattern of the image based on the scattered light.

8. A defect inspection apparatus, comprising:
an irradiation unit that irradiates illumination light on an object to be inspected;
a detection unit that detects scattered light which is scattered from the object to be inspected due to irradiation by the irradiation unit; and
a defect detection unit that has:
a first pixel-value information collecting unit that divides an image based on the scattered light detected by the detection unit into a plurality of areas and obtains first pixel value information which is information of pixel values about each of the areas;
a second pixel-value information collecting unit that obtains second pixel value information which is information of pixel values about all the areas by processing the first pixel value information which was obtained by the first pixel-value information collecting unit;
a similarity calculation unit that calculates similarity between each image of the areas and an image of all the areas by comparing the first pixel value information and the second pixel value information; and
a defect extraction unit that extracts a defect of the object to be inspected by using the similarity calculated by the similarity calculation unit.

9. The defect inspection apparatus according to claim 8,
wherein in the first pixel-value information collecting unit, first pixel value information that is distribution information of the pixel values about each of the areas, and
wherein in the second pixel-value information collecting unit, second pixel value information that is distribution information of the pixel values about all the areas.

10. The defect inspection apparatus according to claim 8,
wherein the defect extraction unit creates a feature space by designating the similarity calculated by the similarity calculation unit as one feature quantity, and extracts a deviated pixel of the feature space as the defect.

11. The defect inspection apparatus according to claim 8,
wherein the defect detection unit further comprises a feature quantity calculation unit for calculating a feature quantity different from the similarity calculated by the similarity calculation unit, and
wherein the defect extraction unit creates a feature space using the feature quantity calculated by the feature quantity calculation unit and the similarity calculated by the similarity calculation unit.

12. The defect inspection apparatus according to claim 8,
wherein the first pixel-value information collecting unit classifies the image based on the scattered light into a plurality of categories, and subsequently divides the image into the areas for every category.

13. The defect inspection apparatus according to claim 10,
wherein the first pixel-value information collecting unit classifies the image based on the scattered light into a plurality of categories, and subsequently divides the image into the areas for every category of the categories, and
wherein the defect extraction unit creates the feature space for every category of the categories.

14. The defect inspection apparatus according to claim 12,
wherein the first pixel-value information collecting unit performs category classification based on the similarity of a background pattern of the image based on the scattered light.

15. A program product, comprising:
a first pixel-value information collecting unit that divides an image based on detected scattered light into a plurality of areas and obtains first pixel value information which is information of a pixel value about each of the areas;
a second pixel-value information collecting unit that acquires second pixel value information which is information of a pixel value about all the areas by processing the first pixel value information obtained by the first pixel-value information collecting unit;
a similarity calculation unit that calculates similarity between each image of the areas and an image of all the areas by comparing the first pixel value information and the second pixel value information; and
a defect extraction unit that extracts a defect of an object to be inspected using the similarity calculated by the similarity calculation unit.

16. An output unit, comprising:
a detected image display unit that, when illumination light is irradiated on an object to be inspected, displays a detected image based on scattered light which is scattered from the object to be inspected by the irradiation;
a first pixel-value information display unit that divides the detected image displayed on the detected image display unit into a plurality of areas and displays first pixel value information which is distribution information of pixel values about each of the areas;
a second pixel-value information display unit that displays second pixel value information which is distribution information of pixel values about the areas calculated using the first pixel value information displayed on the first pixel-value information display unit; and
a feature quantity image display unit that displays an image which shows a feature of the pixel value of each of the areas calculated based on similarity between the first pixel value information and the second pixel value information.
